(19) United States
(12) Patent Application Publication
(10) Pub. No.: US 2005/0115934 A1
(43) Pub. Date: Jun. 2, 2005

(54) Laser processing for providing linear weld seams

(76) Inventors: Andreas Kettner-Reich, Stuttgart (DE); Dominik Widmann, Bad Liebenzell (DE)

Correspondence Address: FISH & RICHARDSON PC, 225 FRANKLIN ST, BOSTON, MA, 02110, US

(21) Appl. No.: 10/943,140

(22) Filed: Sep. 17, 2004

(30) Foreign Application Priority Data
Sep. 19, 2003 (EP) 03 02 1262.5

(51) Int. Cl. B23K 26/24

(52) U.S. Cl. 219/121.63; 219/161

(57) ABSTRACT

A laser processing machine for providing linear weld seams on a workpiece includes a linearly movable laser welding optic for directing a laser for welding the workpiece towards a weld seam on the workpiece, a support bar extending in the direction of the seam to be welded, a plurality of supports disposed on the support bar for supporting the workpiece, and a plurality of clamping members for clamping the workpiece against the supports.

### CLAIM OF PRIORITY

This application claims priority under 35 USC §119(a) to European patent application, serial number EP 03 02 1262.5-1262, filed on Sep. 19, 2003, the entire contents of which is hereby incorporated by reference.

### TECHNICAL FIELD

The invention relates to laser processing and, more particularly, to laser processing for providing linear weld seams.

### BACKGROUND

An important percentage of workpieces to be industrially welded are casing parts or boxes having linear welding edges in small or medium lot sizes. For these workpieces, heat conduction welding is in general desirable as a welding process, so that seams not requiring further processing can be generated.

The sheet metal edges to be welded together originate mostly from sheet metal sides disposed perpendicularly to each other. The ratios on several longitudinal edges on a workpiece may be identical and symmetrical to a plane that is parallel to the edges to be welded together. For example, boxes with a rectangular cross-section are constructed symmetrically to a longitudinal middle plane. In addition, the seams run rectilinearly. Frequently, the casing parts to be welded together include a circumferential flange or beading.

At present, it is often required to build elaborate work-holding devices for these workpieces, which are adapted to each processing task and each construction component, respectively. In particular, when designing an appropriate work-holding device, circumferential flanges, beadings or other deformations, which must not be damaged during clamping, are to be taken into consideration.

Alternatively or in addition, the welding optic needs to be reset during the processing of different longitudinal edges of the workpiece.

### SUMMARY

The invention relates, at least in part, to a laser processing machine for processing of boxes and casing parts and for providing linear weld seams of a workpiece. The laser processing machine includes a linearly movable laser welding optic that includes a support bar extending in the direction of the seam to be welded and several support members to be disposed on the support bar for supporting the workpiece, as well as a mechanism for clamping the workpiece against the support members. The modularly constructed work-holding device enables easily manageable and cost-effective clamping of workpieces, for example by a clamping mechanism formed by two clamping bars.

Individual support members may, with respect to their geometry, be adapted to the geometry of the longitudinal sides of the boxes or of the casing parts in the region of the longitudinal edge. By means of an appropriate choice with respect to the number and design of the support members as well, the workpiece to be processed can be clamped in an optimal manner. For example, a circumferential flange of the workpiece can be clamped without damage by positioning the support members while taking into consideration the circumferential flange. Additionally, corresponding recesses in the support members and/or clamping bars may be provided.

The workpiece can be clamped in a mirror-symmetrical position, i.e., renewed clamping of the workpiece after a rotation with respect to a rotation axis places the workpiece in a position that is mirror-symmetric with respect to the original position of the workpiece. The positioning of the workpiece starting from the two free ends of the support bar enables this mirror-symmetrical clamping of a box or the like.

A sensor can detect the length of a weld seam, and the detected data can be stored. The sensor or a video camera and an image processing system, thus, can detect individual parameters of the weld seam. If, for example, the length of the seam is detected by a calibrating operation and then stored, and other known parameters, such as the material, are entered, the welding process may be carried out largely automatically.

The laser processing device can be integrated into a laser processing network of one or more solid body lasers associated with different processing stations, one of which may be the laser processing device. In rapid alternation, the work stations can call up the required laser energy from the laser devices integrated into the network. Thus, the intelligent distribution of laser energy without restriction on performance and beam quality and optimization of the efficiency and availability of a laser device can be achieved, and the availability of the entire facility can be increased through the simple conversion of redundancy concepts.

The above-mentioned concepts can be achieved through a process that includes the following processing steps: i) clamping the workpiece by means of a clamping device; ii) adjusting the laser welding optic with respect to angle position and/or distance to the workpiece; iii) welding the first longitudinal edge; iv) rotating the workpiece by 180° with respect to a first rotation axis defined by its longitudinal middle axis; v) welding the second longitudinal edge; vi) rotating the workpiece by 180° with respect to a second rotation axis running perpendicularly to its longitudinal middle axis and through the middle of the workpiece; vii) welding the third longitudinal edge; viii) rotating the workpiece by 180° with respect to the first rotation axis; and ix) welding the fourth longitudinal edge. Furthermore, a sensor can be used to detect the length of the weld seam to achieve a high degree of automation.

The welding can start from one of the corners associated with the opening of the workpiece, such as the opening of the box, that is disposed opposite one of the corners associated with the bottom of the workpiece, in the direction of the latter corner of the workpiece. This corner of the workpiece represents the most efficiently clamped part of the workpiece. Thereby, an increased precision during the processing of the workpiece is achieved.

In a first general aspect, a laser processing machine for providing linear weld seams on a workpiece includes a linearly movable laser welding optic for directing a laser for welding the workpiece towards a weld seam on the workpiece, a support bar extending in the direction of the seam to be welded, a plurality of supports disposed on the support bar for supporting the workpiece, and a plurality of clamping members for clamping the workpiece against the supports.

Implementations may include one or more of the following features. For example, the clamping members can be clamping bars. The machine can be adapted to hold a workpiece in the form of a box or in the form of a casing part. The machine can further include a means for mirror-symmetrical clamping of the workpiece. The support bar, the plurality of supports and the plurality of clamping members can be adapted for clamping the workpiece in first position and for clamping the working piece in a second position, in which the workpiece is oriented in a mirror-symmetric position with respect to the first position. The support bar can be arranged such that the workpiece can be slid over an end of the support bar. The machine can include a sensor adapted for detecting the length of the weld seam and wherein the machine is adapted for storing data detected by the sensor.

In another general aspect, a method of laser welding a workpiece with a laser processing machine having a laser welding optic can include i) clamping the workpiece, ii) adjusting a laser welding optic with respect to an angular position and a distance to the workpiece, iii) welding a first longitudinal edge of the workpiece, iv) rotating the workpiece by 180° with respect to a first rotation axis of the workpiece, v) re-clamping the workpiece, vi) welding a second longitudinal edge of the workpiece, vii) rotating the workpiece by 180° with respect to a second rotation axis of the workpiece, viii) re-clamping the workpiece, ix) welding a third longitudinal edge of the workpiece, x) rotating the workpiece by 180° with respect to the first rotation axis, xi) re-clamping the workpiece, and xii) welding a fourth longitudinal edge of the workpiece.

Implementations can include one or more of the following features. The first rotation axis can be a longitudinal middle axis of the workpiece. The second rotation axis can be an axis running perpendicular to a longitudinal middle axis of the workpiece through the middle of the workpiece. The method can further include detecting a length of a of the weld seam of the workpiece. Welding a longitudinal edge of the workpiece can include beginning the welding at a first corner associated with an opening of the workpiece and ending the welding at a second corner of the workpiece.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a perspective view of a laser processing machine for welding of longitudinal edges of a box.

FIG. 2 is an additional perspective view of the laser processing machine of FIG. 1.

FIG. 3 is a section through the laser processing machine according to FIG. 1 along a line III-III.

FIG. 4 is a section through the laser processing machine of FIG. 1 along a line IV-IV.

FIG. 5 is a side view of the clamping device of the laser processing machine of FIG. 1.

FIG. 6 is a plan view of a box intended for laser processing.

FIG. 7 is a plan view of a sheet metal blank of a box prior to processing with the laser processing machine of FIG. 1.

Like reference symbols in the various drawings indicate like elements.

### DETAILED DESCRIPTION

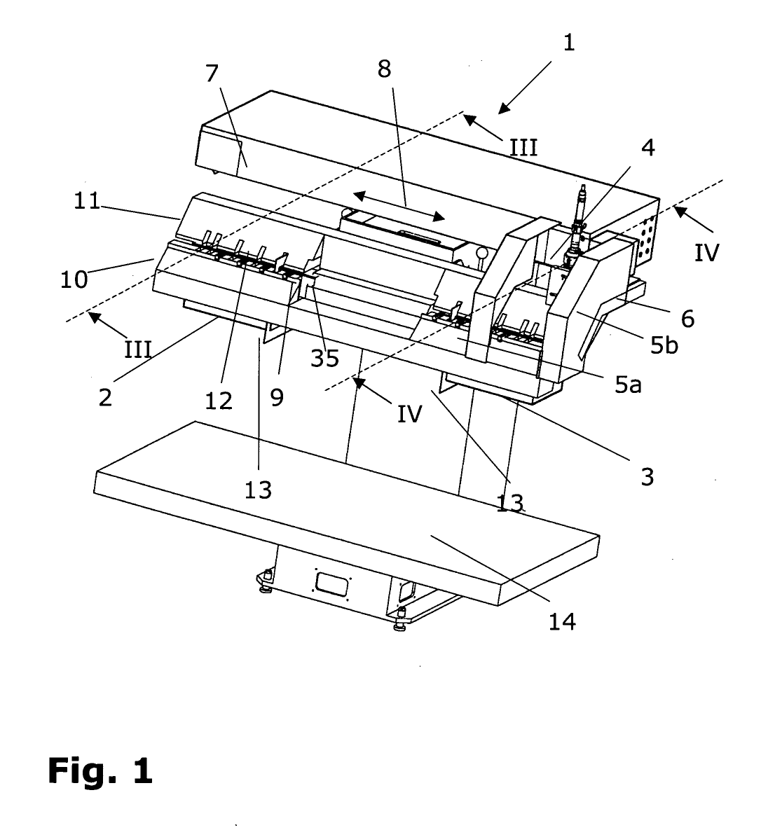

FIG. 1 shows the construction of a laser processing machine 1 for welding linear edges (i.e., longitudinal edges) of boxes 2 and 3. Boxes 2 and 3 having circumferential flanges are shown, however, instead of a box, a similarly constructed object (e.g., a casing part) with linear edges to be welded may be processed with the laser processing machine 1.

The laser processing machine 1 for welding linear edges of boxes 2 and/or 3 includes a laser welding optic 4. The laser welding optic 4 may be shifted with a hood that includes hood parts 5a and 5b and a track 6 along a hood track 7 in direction of a linear axis depicted by double arrow 8. The basic position of the laser welding optic 4 is situated in the middle of the laser processing machine 1. Starting from the basic position, the laser welding optic may be moved to the left side (i.e., towards box 2) or to the right side (i.e., towards box 3). The position of the laser welding optic 4 is manually adjustable with respect to an angle position and to a distance to the workpiece.

A clamping device for the two boxes 2 and 3 includes a support bar, several support members 9 and upper 10 and lower 11 clamping bars. The support bar, on which the support members 9 are disposed and aligned as individual modules, is masked in FIG. 1 and thus not visible. The clamping bars 10 and 11 include recesses 12 that are disposed in a predetermined distance to each other along a longitudinal direction as shown by double arrow 8. Each of the clamping bars 10 and 11 press the boxes 2 and 3 to be processed against the support members 9 and the support bar, respectively. The recesses 12 are provided for a circumferential flange 13 of the boxes 2 and 3, so that the flange 13 is not damaged when clamping the boxes 2 and 3. The distance of the recesses 12 to each other and the length of the support members 9 can be adjusted with respect to each other, so that commonly used projecting flanges of boxes, beadings, or other patterns may be positioned in the recesses 12.

The boxes 2 and 3 to be processed may be slid on the support bar passing over the two free ends of the support bar.

A sensor 35 for detecting the length of the weld seam may be used for a calibrating cycle. The detected data can be stored and used in subsequent processing programs that control the laser processing machine. The only parameter that is entered manually concerns the material, however, all additional parameters necessary for the welding process are storable in the machine 1.

The laser processing machine 1 also includes a height adjustable support table 14 for supporting large parts.

FIG. 1 shows a laser processing machine 1 with a single laser welding optic 4 that may, starting from a position in the middle of the laser weld processing machine 1 (e.g., an idle position), weld outwardly in the direction of the left or right side of the laser weld processing machine 1. Instead of the single laser welding optic 4, two different laser welding optics may weld in the direction of, respectively, the left and the right side of the laser weld processing machine 1.

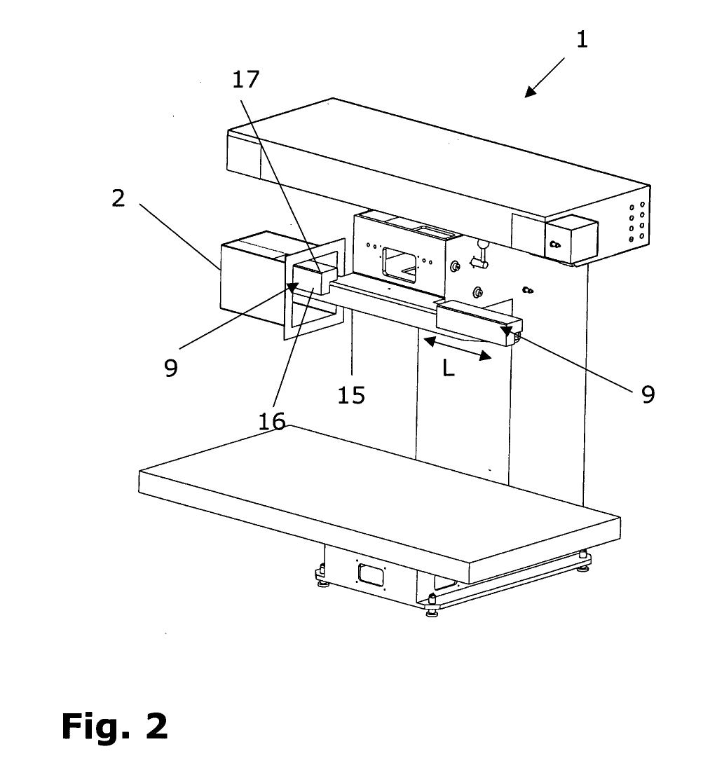

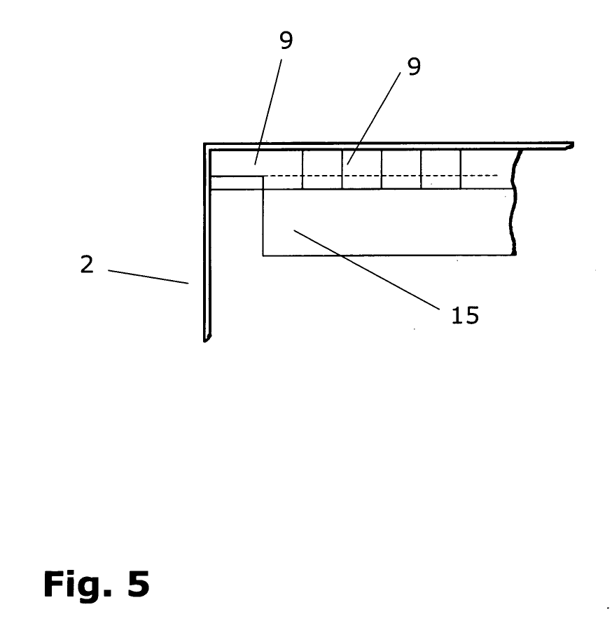

As shown in FIG. 2, the clamping bars 10 and 11, the laser weld optic 4, the hood parts 5a and 5b, and the track 6 are masked so that the support bar 15 is visible. On the support bar 15, support members 9 are disposed on which box 2 rests and may be clamped. For the purpose of taking into account different workpiece lengths and interfering contours and seam geometries of a workpiece to be processed, support members 9 of different lengths L and in different numbers may be positioned on the support bar 15 (see also the support members 9 and 9′ in FIG. 5). The support members 9 are formed as angle profiles, with one leg 16 resting against the support bar 15 and another leg 17 resting on the support bar 15. Thus, the support members 9 may be positioned easily.

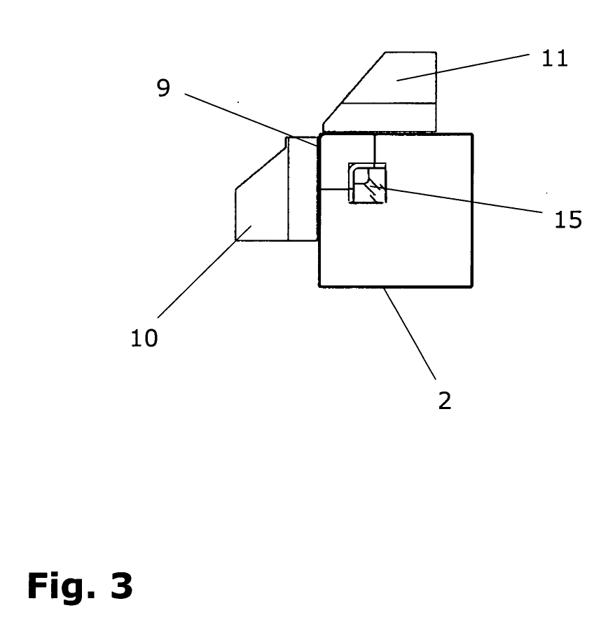

FIG. 3 shows the clamping by way of example with respect to the box 2, through cooperation of the support bar 15, the support members 9, and the clamping bars 10 and 11. The clamping bars 10 and 11, respectively, press across the box 2 on to the outer sides of the legs 16 and 17 of the support members 9. The clamping of the box 2 is performed in an analogous manner.

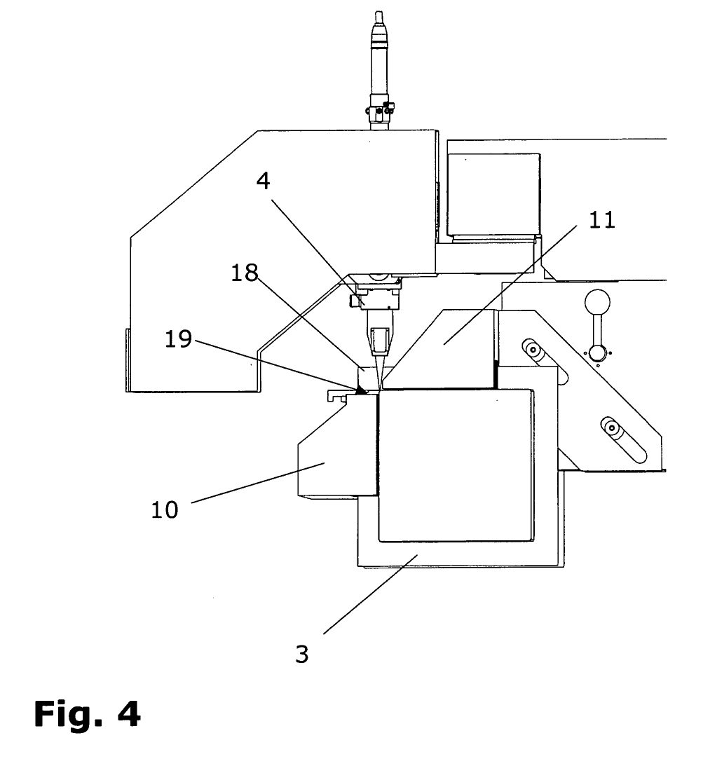

FIG. 4 further shows the area in which the box 3 is welded. The box 3 developed from a sheet metal sheet through folding is fixed between the clamping bars 10 and 11 and the support members 9, so that a laser beam 18 may weld a longitudinal edge 19 of the box 3.

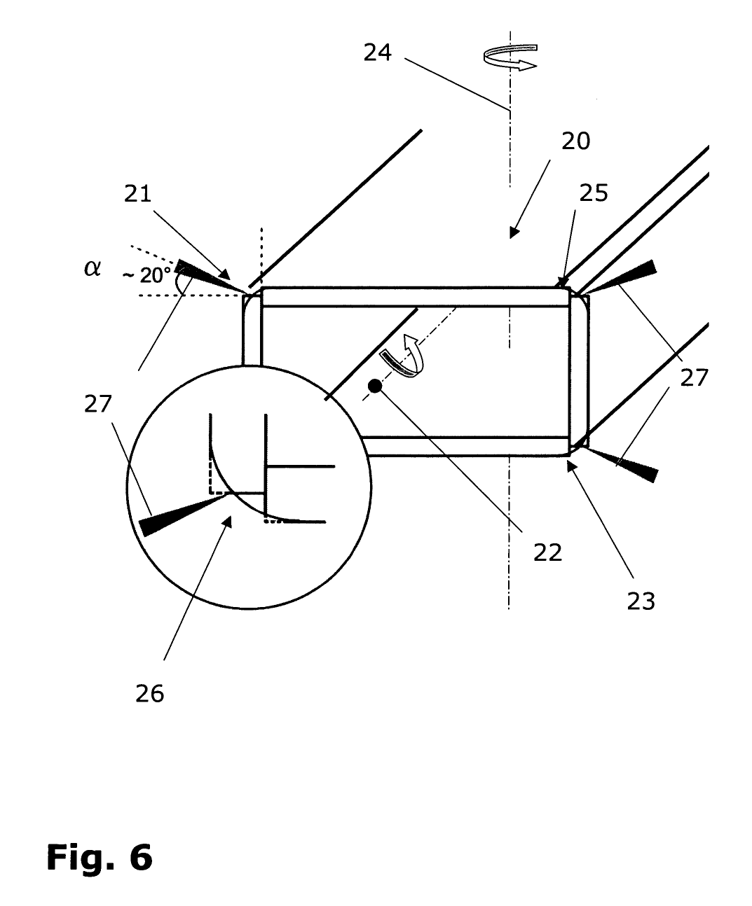

If one longitudinal edge of the box already has been welded, the box must be rotated in order to weld the following longitudinal edge. Therefore, the invention also relates to a process for welding of longitudinal edges of boxes. First, a box 20 is clamped in accordance with FIG. 6. Subsequently, the longitudinal edge 21 is scanned, and data related to the longitudinal edge 21 are detected and stored, such as, for example, the position and length of the seam. The laser processing machine 1 can be adjusted and programmed for the linear welding of the longitudinal edge 21. Because the box constitutes a symmetrically constructed part, the longitudinal edges are equal. Thus, the box 20 having a rectangular cross section can be processed by first welding the longitudinal edge 21 and subsequently rotating the box 20 by 180° with respect to the rotation axis 22 determined by the longitudinal middle axis. Then, the box 20 is clamped again, and the longitudinal edge 23 is welded using the same relation of the laser beam to the workpiece (e.g., angle, distance) as for the longitudinal edge 21. Subsequently, the box 20 is removed, rotated around a rotation axis 24 running perpendicular to the longitudinal middle axis and through the middle of the workpiece, and clamped, so that the longitudinal edge 25 may be welded using the same settings of the laser as for the longitudinal edge 21. The possibility of “mirroring” arises through the use of a support bar that permits the positioning of the box from the left or from the right free end.

Angle settings and spacing of the laser welding optic 4 remain in the same position for the entire process. Lastly, the box is rotated by 180° about rotation axis 22. Then, the box 20 is clamped again, and the longitudinal edge 26 is welded using the same settings of the laser as for the longitudinal edge 21 (i.e., the laser beam 27 is maintained at an angle, α, of about 20°).

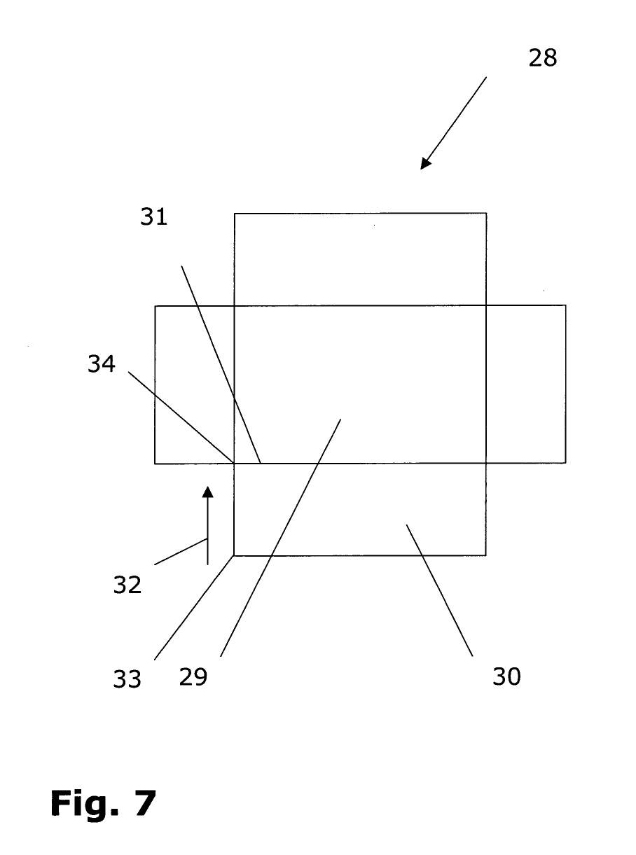

FIG. 7 illustrates the above-mentioned welding direction 32 from outside in the direction of the most firmly clamped edge of the box. A box with a box bottom 29 and box sidewalls 30 may be manufactured from a sheet metal blank 28. The box sidewalls 30 and the box bottom 29 can be folded along a folding line 31 and folded in an analogous manner for the further sides so that a longitudinal seam to be welded is created. Thereafter, welding can be performed in direction 32 (i.e., starting from an outer corner 33 in direction of the corner 34 associated with the box bottom 29).

### Other Embodiments

A number of embodiments of the invention have been described. Nevertheless, it will be understood that various modifications may be made. For example, although linear motions have been described, any kind of relative movement between the workpiece and the laser welding optic can be implemented. Accordingly, other embodiments are within the scope of the following claims.

1. A laser processing machine for providing linear weld seams on a workpiece, the laser processing machine comprising:
a linearly movable laser welding optic for directing a laser for welding the workpiece towards a weld seam on the workpiece;
a support bar extending in the direction of the seam to be welded;
a plurality of supports disposed on the support bar for supporting the workpiece; and
a plurality of clamping members for clamping the workpiece against the supports.

2. The laser processing machine of claim 1, wherein the clamping members are clamping bars.

3. The laser processing machine of claim 1, wherein the machine is adapted to hold a workpiece in the form of a box.

4. The laser processing machine of claim 1, wherein the machine is adapted to hold a workpiece in the form of a casing part.

5. The laser processing machine of claim 1, further comprising a means for mirror-symmetrical clamping of the workpiece.

6. The laser processing machine of claim 1, wherein the support bar, the plurality of supports and the plurality of clamping members are adapted for clamping the workpiece in first position and for clamping the working piece in a second position, in which the workpiece is oriented in a mirror-symmetric position with respect to the first position.

7. The laser processing machine of claim 1, wherein the support bar is arranged such that the workpiece can be slid over an end of the support bar.

8. The laser processing machine of claim 1, further comprising a sensor adapted for detecting the length of the weld seam and wherein the machine is adapted for storing data detected by the sensor.

9. A method of laser welding a workpiece with a laser processing machine having a laser welding optic, the method comprising:
i) clamping the workpiece;
ii) adjusting a laser welding optic with respect to an angular position and a distance to the workpiece;
iii) welding a first longitudinal edge of the workpiece;
iv) rotating the workpiece by 180° with respect to a first rotation axis of the workpiece;
v) re-clamping the workpiece;
vi) welding a second longitudinal edge of the workpiece;
vii) rotating the workpiece by 180° with respect to a second rotation axis of the workpiece;
viii) re-clamping the workpiece;
ix) welding a third longitudinal edge of the workpiece;
x) rotating the workpiece by 180° with respect to the first rotation axis;
xi) re-clamping the workpiece; and
xii) welding a fourth longitudinal edge of the workpiece.

10. The method of claim 9, wherein the first rotation axis is a longitudinal middle axis of the workpiece.

11. The method of claim 9, wherein the second rotation axis is an axis running perpendicular to a longitudinal middle axis of the workpiece through the middle of the workpiece.

12. The method of claim 9, further comprising detecting a length of a of the weld seam of the workpiece.

13. The method of claim 9, wherein welding a longitudinal edge of the workpiece includes beginning the welding at a first corner associated with an opening of the workpiece and ending the welding at a second corner of the workpiece.
